(19) United States
(12) Patent Application Publication
(10) Pub. No.: US 2025/0377230 A1
(43) Pub. Date: Dec. 11, 2025

(54) METERING AND/OR WEIGHING DEVICE FOR FOODSTUFF

(71) Applicant: SWISCA AG, Appenzell (CH)

(72) Inventors: Micha Moosheer, Flawil (CH); Adrian Schaffer, Flawil (CH); Werner Vontobel, Flawil (CH); Andreas Kleiner, Flawil (CH)

(21) Appl. No.: 18/855,677

(22) PCT Filed: Apr. 12, 2023
(86) PCT No.: PCT/EP2023/059483

§ 371 Date: Oct. 10, 2024

(30) Foreign Application Priority Data
Apr. 14, 2022 (CH) CH000448/2022

(51) Int. Cl. G01F 9/00; B02C 4/28

(52) U.S. Cl. CPC G01F 9/005; B02C 4/286; G01F 9/003

(57) ABSTRACT

A metering and/or weighing device includes a bulk material container with a bulk material inlet and a bulk material delivery. The latter is configured to deliver bulk material which is present in the bulk material container, in intervals in a metered and/or controlled manner. The metering and/or weighing device has a radar sensor which is attached to the container at the upper side and generates a beam cone which is directed downwards into an inside of the container, in order to determine a level of the bulk material which is present in the container.

### BACKGROUND OF THE INVENTION

### Field of the Invention

The invention relates to foodstuff processing and specifically to the processing of cereal products. It especially relates to a metering or weighing device for bulk material, as is applied on processing cereal products by machine.

### Description of Related Art

Such metering and/or weighing devices are present as constituents of machines and also as autonomous machines (“stand-alone devices”). Examples of a device as a constituent of a machine are the feed of a roller mill or also a weighing and metering device of a flour filling facility. Examples for autonomous machines are bulk scales or differential scales.

GB 2 119 104 teaches the feeding of for example fibrous material or also cereal, to a process whilst determining its weight and additionally its moisture content and volume.

Metering and/or weighing devices each include a bulk material container, from which the bulk material is transported further in a metered manner, or in which the bulk material is collected and weighed for the purpose of metering.

With regard to metering devices without a weighing unit, thus for example the feed of a roller mill, there is generally the need to monitor the filling level of this bulk material container. For this purpose, it has been suggested to use a weight which is determined by a force transducer, wherein the force transducer is arranged in the bulk material container. The force upon a weight transducer however is only a measure of the filling degree to a limited extent, since apart from the filling level it also depends on yet further parameters, for example the density of the bulk product and, depending on the arrangement and design, on yet further characteristics such as the grain size or the flow characteristics. In order to take into account these circumstances, EP3605034 suggests the use of a capacitive level sensor additionally to the force transducer. The level sensor determines when a certain lever in the bulk material container has been reached, and this information can be used for calibration. This solution has the disadvantage that it is relatively complicated. Elsewhere, capacitative rod sensors are used for monitoring the filling level. These have the advantage that they can measure the filling level independently of the density. However, they are prone to malfunction due to the sticking of material. U.S. Pat. No. 5,433,391 shows a roller mill with a capacitative filling level measurement.

Likewise known is the level measurement via a plurality of light barriers which are arranged at different heights. However, light barriers are also prone to malfunction due to dust and the sticking of material.

With regard to metering devices with a weighing unit, the weight measurement also at the same time provides information on the filling level in the respective container. The disadvantage of the density dependence however also exists with these devices, i.e. the level cannot be determined directly from the filling weight.

### SUMMARY OF THE INVENTION

It is an object of the present invention to provide a metering and/or weighing device which overcomes the disadvantages of the state of the art and which in particular renders possible a reliable and robust estimation of the filling level and herein is as simple and inexpensive as possible.

According to an aspect of the invention, the metering and/or weighing device includes a bulk material container, with a bulk material inlet and a bulk material delivery. The latter is configured to deliver bulk material which is present in the bulk material container, in intervals in a metered and/or controlled manner. The metering and/or weighing device is characterised by a radar sensor which is attached to the bulk material container at the upper side and generates a beam cone which is directed downwards into the inside of the container, in order to determine a level of the bulk material which is present in the container.

The metering and/or weighing device is configured for the metering and/or weighing of foodstuff products, in particular cereal products. Cereal grain as well as products which arise on size reduction of cereal grains, thus flour, middling, semolina, groats, etc. are denoted as cereal products. The grain size of the bulk material (the average diameter) in particular can be up to a few millimetres, for example up to 5 mm or up to 3 mm. The finest possible grain size is that of flour, thus less than 0.18 mm or less than 0.112 mm, wherein the average grain size can be roughly 0.07-0.1 mm or also more or less than these values, depending on the flour type.

Radar sensors are known per se, amongst other things for measuring distances. One measuring principle can be based for example on frequency modulation by way of the frequency being continuously changed. The frequency difference between the emitted radar signal and the one which is thrown back by the object is then a measure for the so-called time-of-flight and thus for the distance between the radar sensor and the object. Radar sensors have also already been suggested for example for the measurement of the filling level of high silos and large bunkers. The measurement of the time-of-flight is herein particularly effected amid the use for frequency modulation by way of the radio signal being emitted in a continuous manner, but with a continuously changing frequency. Herein, the time-of-flight results from the comparison of the frequencies of the emitted radio radiation and the received signal. Radar measurements of this type have already been suggested for the measurement of the filling level of large silos which serve as stores for products in industrial processes, in particular in the chemical industry. CN211033818U and US 2021/0140811 show corresponding examples. EP3913335 and DE10 2012 109 101 discuss the issue of aspects of such filling level measurements with regard to measurement technology.

However, such silos include no bulk material inlet, through which bulk material could be able to be fed during operation. For this reason alone and on account of their dimensions, such would be unsuitable for applications for example in a milling facility. Moreover, the taught measuring principles assume a defined surface of the bulk material. A precondition for the functioning of such measurements is specifically that the reflection of the radio signal takes place at a defined location.

This precondition however is not given in metering and/or weighing devices for cereal products, for reasons which are yet explained hereinafter.

A recognition, on which the present invention is based, is the fact that despite such circumstances, radar sensors are also suitable for the filling level monitoring of bulk material containers for weighing and metering devices for foodstuff products, despite these containers being orders of magnitude smaller and the corresponding devices being unequally more filigree. Furthermore, the dimensions are relatively small in comparison to the wavelength of the applied radio radiation; the distance between the emitter and the reflecting surface can be significantly less than 1000 wavelengths. Also, it is generally difficult to measure distances with radar sensors in cramped receptacles, since there can be many reflections, for example on walls, and the background (reflections on the vessel base and devices in its proximity such as conveying screws, flaps, etc.) also does not deliver signal components which can be neglected. Furthermore, flour-like products are poor reflectors, since the radio waves can penetrate relatively deeply and reflections can take place not only on the surface. In contrast, the reflection behaviour is diffuse. A further characteristic of metering and/or weighing devices for foodstuff products which are present as bulk material is the presence of the bulk material inlet as well as bulk material delivery, through which bulk material is fed and led away respectively during the operation. In particular, the bulk material feed is configured such that bulk material can also be fed and is fed during an operation during which measurements of the level are also effected. The feeding of the bulk material for example to the metering device of a roller mill can be effected continuously, i.e. there is a continuous product flow into the metering device, which amongst other things has the effect that a compact dust is often constantly present above the product level. Despite all these points, it has been found that good results can be achieved by way of existing measurement techniques.

Accordingly, the metering and/or weighing device is configured to detect the level, even whilst bulk material is fed through the bulk material inlet.

Coherent radar systems have been found to be particularly favourable. It has been found that coherent radar systems are particularly suitable for eliminating interference signals which are due to reflections and the background. Pulse radar systems concerning which the emitting impulses are coherent, i.e. have a defined phase relation, are denoted as coherent radar systems. Coherent radar systems according to the state of the art in particular are known for detecting moved targets (for example aircraft).

In this context, the metering and/or weighing device in particular can be configured to measure the precise phase position of the pulses in an initial measurement and on determining the level to subtract it from the measurement signal for the purpose of cancelling out the background (which is to say not to take into account signal components with this phase position). By way of this, one utilises an advantage of the coherent radar system given a fixed installation (such is present with a device according to the invention): the reflections can be empirically taken into account by way of such an initial measurement. This is also the case when the reflections for example are damped on account of a filling of the container during the determining of the level, and is also the case without an exact model of the container and its interaction with the radio beams becoming necessary. This can be taken into account with each measurement of the level which is subsequent to the initial measurement, on account of the coherency of the radar.

A distance between the radar sensor and the base of the volume in the container which is to be monitored is relatively small, for example maximally approx. 3 m or even maximally 1.5 m, with devices of the type according to the invention. The distance can be measured for example between the radar sensor on the one hand and the control element on the other hand. The control element is the element, through which the delivery of bulk material is effected, e.g. the feed roller together with a slide given a roller mill feed or the outlet flap or outlet slide given a bulk material scale or a throughput quantity controller. The distance between the radar sensor and the control element can be for example between 0.1 m or 0.2 m and 3 m, in particular between 0.3 m and 1.5 m.

The radar sensor can be configured to detect minimal distances of down to 0.2 m or even down to 0.1 m or less. The device can be configured to go into an alarm state or safety state when the minimal measurable distance or a settable minimal distance (corresponding to a maximal filling level) is fallen short of.

In particular, the radar sensor includes a radio wave transmitter (emitter) as well as a corresponding receiver. Radio wave transmitters and receivers in particular can be part of a radar sensor module and be present for example on a common circuit board, for example even integrated in a common integrated circuit. Apart from this, such a radar module also includes evaluation means for carrying out evaluation steps of the received signal. Hence the radar sensor module, as mentioned, in particular can be designed to emit the radio waves in the form of coherent emitting pulses, wherein a determining of the time-of-flight preferably takes place directly in the radar sensor module, in the local proximity to the transmitter and receiver.

Apart from the radar sensor module, the radar sensor can yet include a housing or another carrier structure as well as a lens which is arranged at a distance of approx. 1-5 cm to the radio wave transmitter and bundles the emitted radio waves. Such lenses can consist for example of plastic.

In many application cases, it has been found to be particularly advantageous if the opening angle of the beam cone which comes from the radar sensor—possibly after a suitable bundling—has an opening angle of between 5° and 15°. In this range, the results of the measurement of the bulk material level in the container of the type described here are particularly good and reproducible. Given larger opening angles, effects which arise for example by reflections on the vessel wall, as well as an averaging over too large a surface area region can render the result somewhat fuzzy, whereas given smaller opening angles the radiation intensity can be locally too high.

A metering and/or weighing device of the type which is described here in particular serves for the metering of cereal products (or possibly other foodstuffs arising as bulk material) on processing and/or packaging by machine. For this purpose, it includes a control element, by way of which the delivery of the bulk material is effected.

If the device is a feed of a roller mill, then this control element is formed for example by a feed roller, together with a means for metering the delivery quantity which is transferred by the feed roller, in particular in an automatically controllable manner. Such a metering means can include for example the control of the drive of the feed roller which can rotate at different speeds. Supplementarily or alternatively, a feed gap through which the feed roller transports the material which is conveyed in a metered manner can have an adjustable dimension.

If the device is a scale for the bulk material, for example a bulk scale or a differential scale, then the control element is formed by an electrically or pneumatically operated outlet flap or an electrically or pneumatically operated outlet slide. The outlet flap or the outlet slide can be configured for the complete opening and complete closing during respective intervals and/or for the continuous controlling of the through-flow cross section—depending on the desired application.

If the device is a scale, thus including a weighing unit with at least one load cell for determining the weight, then it can also be configured to determine a value for the density of the bulk material. This results due to the fact that the determined level permits an estimation of the bulk material volume in the container whilst utilising geometric data on the container and/or previously determined calibration data which is stored in the control of the device.

Independently of the use, the control which reads out the data of the radar sensor—or also the radar sensor itself—can be configured to communicate with a super-ordinate control and/or with other devices, for example a mill—for example for the purpose of the closed-loop control of the feed of bulk material through the bulk material inlet.

Supplementarily or alternatively, the control of the metering and/or weighing device (which can also be part of a superordinate control) can be configured to closed-loop control the bulk material delivery in a manner depending on the data of the radar sensor.

If the metering and/or weighing device is a feed device of a roller mill for processing foodstuffs, then as mentioned above, the bulk material delivery will include for example a feed roller which brings out bulk material which is present in the container (“collection space”) into a further space, wherein it is reduced in size between (grinding) rollers or—depending on the effected processing—is also merely flatly pressed. A conveying means, for example a conveying roller can also be present in the container, the conveying means distributing the bulk material along the axial extension of the feed roller. In embodiments, the control of the metering and/or weighing device is configured to set a rotation speed of the feed roller and/or a width of the feed gap between the feed roller and an aperture and/or possibly a conveying speed of the conveying means, in dependence on the level which is determined by the radar sensor.

Apart from the metering and/or weighing device, a roller mill is also the subject-matter of the present invention. Apart from a processing unit with at least one pair of rollers, between which a cereal product is reduced in size and/or pressed, this also includes a metering and/or weighing device which serves as a feed device of the roller mill and is of the type which is described in this text. In particular, the metering and/or weighing device can then include a feed roller, wherein the bulk material quantity which can be bought out per unto of time by the feed roller can be adjusted, for example by way of adjusting the rotation speed of the feed roller and/or possibly also another parameter, for example the width of the mentioned feed gap. The control of the metering and/or weighing device—which can be part of the roller mill control or also part of a super-ordinate control, for example of a complete mill facility—in embodiments is designed and configured to adjust the bulk material quantity which is brought out per unit of time, in dependence on the level which is determined by the radar sensor.

The use of a metering and/or weighing device of the type which is described in this text, for metering a cereal product in a mill is likewise the subject-matter of the invention. Herein, in particular the level which is determined by the radar sensor can be used in order to adjust the quantity of bulk material which is brought out per unit of time.

With regard to such a use, in particular the feed through the bulk material inlet is effected in a continuous manner, and/or the determining of the level is effected continuously.

In particular, the use envisages detecting the level also whilst bulk material is fed through the bulk material inlet.

Supplementarily or alternatively, the quantity of bulk material which is brought in through the bulk material inlet per unit of time can be adjusted, for example by way of controlling a corresponding control element (for example a slide) or a machine, for example a plansifter, which is arranged upstream.

### BRIEF DESCRIPTION OF THE DRAWINGS

Embodiment examples of the invention are hereinafter described by way of drawings. In the drawings, the same reference numerals denote equal or analogous elements. The drawings are all schematic. In part, they show elements which partly correspond to one another, in sizes which vary from figure to figure. There are shown in:

FIG. 1 a view of a roller mill;

FIG. 2 a cross section through a feed of roller mill;

FIG. 3 a radar sensor;

FIG. 4 a cross section through a bulk scale; and

FIG. 5 a cross section through a differential scale.

### DETAILED DESCRIPTION OF THE INVENTION

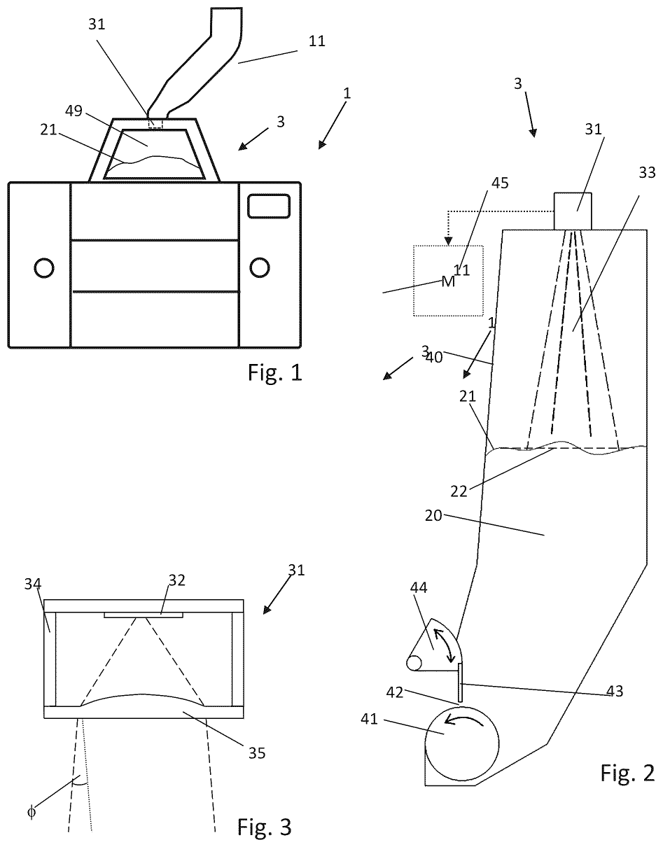

FIG. 1 shows a roller mill 1 as is used in cereal mills. The roller mill includes at least one housing, in which at least one pair, often several pairs, of rollers is/are arranged. The cereal product which is brought in from above is reduced in size and/or pressed between the rollers of the roller pair. For the purpose of feeding a metered quantity of the cereal product, the roller mill includes a feed 3 which is designed as a device according to the invention.

The feed 3 which is represented schematically in cross section (section plane perpendicular to the picture plane of FIG. 1) in FIG. 2 includes a bulk material container 40 with a bulk material inlet 11 as well as a bulk material delivery. The latter is formed by a feed roller 41 and a feed slide 43 which is movable relative to the feed roller by way of a suitable mechanism 44, and between which a feed gap 42 forms, through which gap the bulk material 20 is transported onwards by the at least one roller pair for the purpose of processing. The possibility of the inside of an upper part of the container 40 being able to be viewed from the outside through a viewing window 49 is illustrated in FIG. 1.

The radar sensor 31, specifically a pulsed coherent radar sensor is assembled on the container 40 at the upper side. It generates a beam cone 33 of radio wave radiation which is directed downwards onto the (free) surface 21 of the bulk material 20 and detects radiation which is reflected by the surface 21. The time-of-flight of the radio wave radiation to the surface and back to the sensor can be determined by way of the measurement of the reflected radiation. Double the distance between the radar sensor 31 and the surface 21, and herewith the level 22, thus the degree of filling results directly from the time-of-flight.

The applied radio wave radiation can have a comparatively short wavelength corresponding to a frequency of for example above 50 GHz, for example roughly 60 GHz. In particular, the radio waves are consequently microwaves as are characteristic for radar technology. In radar technology, the applied microwaves are sometimes also called “radar waves”. Within the possible spectrum of radar waves, in the present context it is relatively short-waved radar waves with frequencies above 20 GHZ, in particular above 50 GHz and for example as mentioned roughly 60 GHz which are of interest.

The measurement value for the filling level (level 22) which is determined by the radar sensor 31 is transferred to a control module 45. This control module 45 can form the control of the complete roller mill 1 or be an independent control module of the feed 3. In particular, it can communicate directly or indirectly with other units of a facility, to which the roller mill belongs, in order for example to influence the feed of the cereal product to the roller mill. The feed slide 43, the feed roller 41 and/or further elements of the feed which are not shown in FIG. 2, for example a conveying screw for the horizontal distribution of the cereal product can also be controlled by the control module 45.

The radar sensor 31 which is also represented in FIG. 3 includes a radar sensor module 32 with one or more integrated circuits, for example on a circuit board. The radar sensor module includes, under certain circumstances in an integrated manner, a transmitter and a receiver as well as evaluation electronics. Furthermore, the radar sensor 31 includes a carrier structure with a lens holder 34 as well as a convergent lens 35 for bundling the emitted radio radiation. The lens can be manufactured for example from a plastic and under certain circumstances it can be created in a tailored manner with a method of additive manufacturing technology (“3D-printing”).

The lens 35—or very generally bundling optics of the radar sensor—in particular can be designed such that the opening angle φ of the beam cone is between 5° and 15°, in particular between 6° and 12°, for example roughly 8°. It has been found that opening angles in this range result in an effect which is optimised for the applications which are described in this text. On the one hand, given a larger opening angle, the scatter effect of the vessel walls would be significant, and the signal would be averaged over too large a region of the surface 21 and therefore be fuzzy. On the other hand, given smaller opening angles, the radio power would have to be greatly reduced so that too high, potentially harmful radiation powers do not result. A reduction of the radio power, however, would have a negative effect on the signal quality.

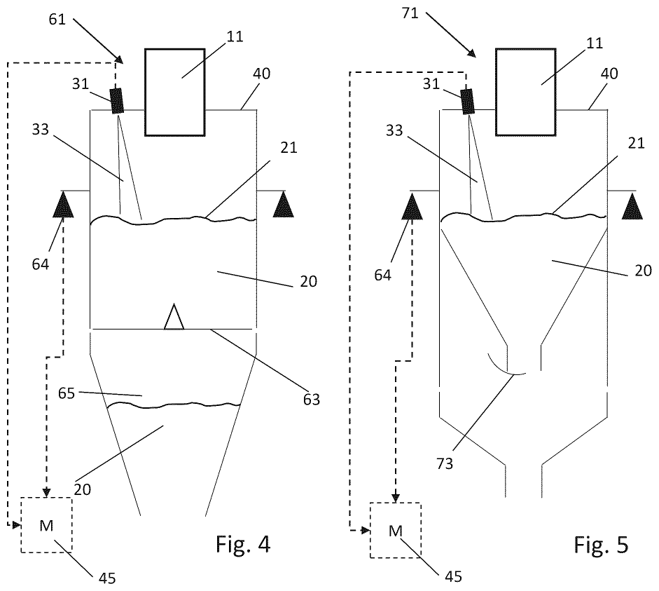

FIG. 4 shows an example of a further metering and/or weighing device, specifically a bulk scale 61 for cereal products and other foodstuff products which are present as bulk material. The bulk scale likewise includes a container 40 and a bulk material inlet 11. Furthermore, it is equipped to measure a weight of the bulk material which is present in the inside of the container. For this purpose, it includes at least one load cell 64 which either measures the weight of the complete container 40 with the contents, from which the weight of the bulk material 20 can be determined whilst taking into account calibration data, or which can alternatively also measure the weight force which bears on an element in the inside of the container, for example on an outlet flap 63.

As is known per se for bulk scales, the bulk material is admitted through the bulk material inlet 11 in portions, which is why for example an inlet flap (not drawn in FIG. 4) can be present and which can open and close the bulk material inlet in a controlled manner by way of a control module 45. The weight measurement takes place when no bulk material is fed and the outlet flap 63 is closed. The outlet flap 63 is opened subsequently to the measurement and the container is thus emptied by way of the bulk material getting into an outlet region 65, from which it can continuously flow away.

Similarly to the aforedescribed feed 3 for a roller mill 1, the radar sensor 31 serves for determining the distance to the surface 21 of the bulk material and herewith for determining the filling level. The information on the filling level which is determined in such a manner can firstly very generally be used for the control of the processes. For example, one can ensure that the container is not overfilled at any point in time, which could adulterate measurements and possibly block elements.

Secondly, in particular one can envisage the control module 45 effecting a measurement being carried out by the radar sensor when (also when or only when) no bulk material is fed and the outlet flap 63 is closed. The filling level is then a measure for the volume of the bulk material whose weight is measured. From this, the density of the bulk material can be determined in an approximate manner. Although the volume measurement is generally significantly less precise in comparison to the weight measurement, since the exact course of the surface 21 is not taken into account and cannot even be determined with a single radar sensor, even an approximate evaluation of the bulk material density however is also valuable and despite this can be used for the control of the bulk material quantity which is respectively fed to the scale. A value for the density can also represent valuable information for other devices of a facility to which the determined value can be provided. By way of this, in contrast to the state of the art, for example control procedures and manual adjustments by an operator can be spared, for example if one changes between different types of processed bulk material (for example between grains, flour, semolina, coarse meal, different cereal types, etc).

FIG. 5 shows a further bulk material scale, specifically a differential scale 71. In contrast to the bulk scale 61 of FIG. 4, the bringing-out of the bulk material is not effected in intervals in an intermittent manner, but through an outlet flap 73 with a controllable throughput. With this scale too, the weight in the container is measured and the weight which flows out of the container 40 per unit of time is also determined, in particular during which no feed of bulk material is effected. This can be used for the closed-loop control of the throughput through the outlet flap 73. The function of the radar sensor 31 is analogous to the bulk scale 61 according to FIG. 4.

1. A metering and/or weighing device for foodstuff products which are present as bulk material, with a container with a bulk material inlet for feeding bulk material into the container and with a bulk material delivery which is configured to deliver bulk material which is present in the container, in intervals in a metered and/or controlled manner, wherein a radar sensor which is attached to the container at the upper side and generates a beam cone which is directed downwards into an inside of the container, in order to determine a level of the bulk material which is present in the container.

2. The metering and/or weighing device according to claim 1, wherein the radar sensor comprises a radar sensor module with a radio wave transmitter and a radio wave receiver as well as a convergent lens, wherein the lens is arranged at a distance to the radar sensor module in order to bundle radio radiation which is emitted by the radio wave transmitter.

3. The metering and/or weighing device according to claim 1, wherein an opening angle (φ) of the beam cone is between 5° and 15°.

4. The metering and/or weighing device according to claim 1, wherein the bulk material delivery comprises a control element which comprises a feed roller or an electrically or pneumatically actuatable shut-off element.

5. The metering and/or weighing device according to claim 1, wherein a distance between the radar sensor and the bulk material delivery is between 0.1 m and 3 m.

6. The metering and/or weighing device according to claim 1, being a feed of a roller mill and comprising a feed roller, through which feed roller a meterable quantity of a cereal product can be delivered to a cereal product processing unit of the roller mill which is arranged downstream.

7. The metering and/or weighing device according to claim 1, further comprising a weighing unit with a load cell for determining a weight of the bulk material which is contained in the container.

8. The metering and/or weighing device according to claim 7, which is configured to determine a density of the bulk material from the determined level as well as the determined weight.

9. The metering and/or weighing device according to claim 7, which is a bulk scale or a differential scale for bulk material.

10. A roller mill comprising a processing unit with at least one pair of rollers between which a cereal product is reduced in size and/or pressed, as well as the metering and/or weighing device according to claim 6 for metering a feed of the cereal product to the processing unit.

11. (canceled)
